(19) United States
(12) Patent Application Publication
(10) Pub. No.: US 2001/0051511 A1
(43) Pub. Date: Dec. 13, 2001

(54) Transmitting power control equipment and transmitting equipment

(75) Inventors: Shinji Kakizaki, Sapporo (JP); Shigeki Takahashi, Kawasaki (JP); Katsuhiko Kawasaki, Kawasaki (JP)

Correspondence Address: HELFGOTT & KARAS, P.C., Empire State Building, 60th Floor, New York, NY, 10118, US

(73) Assignee: FUJITSU LIMITED

(21) Appl. No.: 09/745,045

(22) Filed: Dec. 20, 2000

(30) Foreign Application Priority Data
Jun. 8, 2000 (JP) 2000-172433

(51) Int. Cl. H04B 1/04; H04Q 7/20

(52) U.S. Cl. 455/116; 455/115; 455/522

(57) ABSTRACT

The invention relates to transmitting power control equipment for controlling the level of a transmission wave at the transmitting end of a radio transmission system and transmitting equipment incorporating this transmitting power control equipment. In the radio transmission system to which the invention is applied, the gains of amplifiers disposed individually in a pre-stage and a subsequent stage of means for executing frequency conversion in a transmission wave generation process are kept at suitable values with respect to a level at which the transmission wave is to be transmitted, and are properly updated. Therefore, transmission quality can be highly maintained over a broad dynamic range of transmitting power to be set, in comparison with prior art equipment.

### BACKGROUND OF THE INVENTION

1. Field of the Invention

This invention relates to a transmitting power control equipment for controlling a level of a transmission wave at a transmitting end of a radio transmission system, and to a transmission equipment to which the transmitting power control equipment is applied.

2. Description of the Related Art

In recent years, a CDMA system has been broadly applied to a mobile communication system and other radio transmission systems in order to accomplish transmission of diversified transmission information in addition to effective utilization of a radio frequency.

In such a mobile communication system, a mobile station can exist at a proximate point of a radio base station and at an outer edge portion of a wireless zone formed by the radio base station. Therefore, transmission characteristics of a radio transmission path formed between these stations may broadly vary.

For this reason, a level of transmitting power of both or either one, of the mobile station and the radio base station is appropriately varied under channel control that is directed to secure desired transmission quality and service quality.

The mobile communication system to which the CDMA system is applied can generally accomplish high confidentiality and high interference resistibility. To solve the near-far problem that is inherent to this CDMA system, transmitting power in mobile station equipment and radio base station equipment is broadly controlled up to about 70 dB.

FIG. 11 shows a structural example of a transmitting/receiving part of the mobile station equipment for controlling transmitting power.

In the drawing, modulation signals I and Q, that correspond to two orthogonal channels, respectively, are applied to modulation inputs of a transmitting part 40. An antenna terminal of a transmitting part 40 is connected to a transmission input of an antenna duplexer (DUP) 50. An antenna terminal of the antenna duplexer 50 is connected to a feeding point of an antenna 51, and a reception output of the antenna duplexer 50 is connected to an input of a receiving part 60. A control terminal of the receiving part 60 is connected to a corresponding input port of a controlling part 70. Demodulation signals i and q, that correspond to the two orthogonal channels, respectively, are acquired at an output of the receiving part 60, and are applied to corresponding inputs of a controlling part 70. An output of the controlling part 70 is connected to the corresponding input of the transmitting part 40.

The transmitting part 40 comprises the following constituent elements:

an oscillator 41;

an orthogonal modulator 42 having modulation inputs to which the modulation signals I and Q described are applied, and a carrier signal input directly connected to an output of the oscillator 41;

an intermediate frequency amplifier 43, a frequency converting part 44, a high-frequency amplifier 45, a band-pass filter 46 and a power amplifier 47 that are cascaded with one another in a subsequent stage of the orthogonal modulator 42; and

a gain controlling part 80 having an output directly connected to the output of the controlling part 70 and two outputs directly connected to the control inputs of the intermediate frequency amplifier 43 and the high-frequency amplifier 45, respectively.

The gain controlling part 80 comprises the following constituent elements:

resistors 81 and 82 one end each of which is connected directly and commonly to the output of the controlling part 70;

an operational amplifier 83 having its non-inverting input connected to the other end of the resistor 81 and its output directly connected to the control input of the intermediate frequency amplifier 43;

a resistor 84 having both of its ends connected to the output and the inverting input of the operational amplifier 83;

a resistor 85 for grounding the inverting input;

an operational amplifier 86 having its non-inverting input directly connected to the other end of the resistor 82 and its output directly connected to the control input of the high-frequency amplifier 45;

a resistor 87 having both of its ends connected to the output and the inverting input of the operational amplifier 86; and

a resistor 88 having both of its ends connected to the inverting input and a voltage source that applies a predetermined reference voltage Vr (assumed hereby as 3 V for the sake of simplicity).

In the mobile station equipment having such a construction, the receiving part 60 demodulates the reception waves that reach the antenna 51 from a radio base station, not shown, and are given through the antenna duplexer 50, and outputs the demodulation signals i and q described above. The receiving part 60 suitably applies information of this reception wave such as the field strength level to the controlling part 70.

The controlling part 70 processes these demodulation signals i, q and the field strength level on the basis of a predetermined channel control procedure, and generates a control signal representing the level of the transmission wave to be transmitted from the local station as the instantaneous value Vc of the voltage in order to solve the near-far problem described above.

The instantaneous value Vc of the control signal will be hereinafter referred to merely as the “control voltage Vc”.

Explanation of the channel control to be conducted for generating this control voltage Vc will be hereby omitted.

In the transmitting part 40, on the other hand, the orthogonal modulator 42 orthogonally modulates the carrier signals generated by the oscillator 41 in accordance with the modulation signals I and Q described already, and generates modulated wave signals.

The intermediate frequency amplifier 43 amplifies this modulated wave signal at a gain G1 proportional to the control voltage V1 that is given by the gain controlling part 80 as will be later described.

The frequency converting part 44 frequency-converts the modulated wave signal given through the intermediate frequency amplifier 43 and generates a high-frequency signal containing the component of the modulated wave signal in a desired occupied band.

The high-frequency amplifier 45 amplifies this high-frequency signal at a gain G2 proportional to the control voltage V2 that is given by the gain controlling part 80 as will be later described.

The band-pass filter 46 suppresses or eliminates, in the frequency domain, the component of the useless noise contained in the side band of the high-frequency signal among the components of the high-frequency signal given through the high-frequency amplifier 45.

The power amplifier 47 amplifies the high-frequency signal given through the band-pass filter 46 at a predetermined gain, and feeds it to the feeding point of the antenna 51 through the antenna duplexer 51.

Incidentally, the dynamic range of the transmission wave to be varied under transmitting power control must be at least about 70 dB as already described.

In the operational amplifier 83 inside the gain controlling part 80, the gain is set in advance as the combination of the resistance values of resistors 81, 84 and 85. As a control voltage V1 of the instantaneous value, that increases or decreases in proportion to the control voltage Vc, is given to the intermediate frequency amplifier 43, the gain G1 of the intermediate frequency amplifier 43 is increased or decreased within the range at least the half of the dynamic range described above. (Here, this range is assumed to be 40 dB for simplicity).

The operational amplifier 86 gives the control voltage V2, that is set in advance as the combination of the values of resistors 82, 87 and 88 and as the reference voltage Vr described above and is the instantaneous value increasing or decreasing in proportion to the control voltage Vc, to the high-frequency amplifier 45, and increases or decreases the gain G2 of this high-frequency amplifier 45 within the range (that is assumed hereby as 30 dB (=70−40) for simplicity) that cannot be varied by the intermediate frequency amplifier 43 in the range inside the dynamic range described above.

In other words, since the gain G1 of the intermediate frequency amplifier 43 and the gain G2 of the high-frequency amplifier 45 are set in parallel to the values proportional to the control voltage Vc, the overall gain of the transmitting part 40 can be reliably varied throughout the dynamic range of 70 dB in which transmitting power control is to be made.

In the prior art example described above, the gain G1 of the intermediate frequency amplifier 43 and the gain G2 of the high-frequency amplifier 45 are varied in parallel with each other. Therefore, in order for the level of the transmission wave transmitted from the antenna 51 to be set to a low level, it has been necessary to set both of the gain G1 of the intermediate frequency amplifier 43 and the gain G2 of the high-frequency amplifier 45 to small values.

However, the level of the noise such as thermal noise occurring inside the intermediate frequency amplifier 43 is substantially constant irrespective of the gain G1. Therefore, a signal-to-noise ratio (DU ratio) of the intermediate frequency signal acquired at the output end of the intermediate frequency amplifier 43 remarkably drops when the level of the transmission wave is low, so that the signal-to-noise ratio of the transmission wave transmitted from the antenna gets deteriorated.

In other words, transmission quality of an upward radio transmission channel, that is generally evaluated as adjacent channel leakage power ACLR and evaluation of modulation EVM, is likely to remarkably drop in a period in which the mobile station equipment exists at a proximate point of the radio base station because the output level of the transmission wave is suppressed to a low level.

### SUMMARY OF THE INVENTION

It is an object of the invention to provide a transmitting power control equipment and a transmitting equipment each capable of maintaining high transmission quality over a broad dynamic range in which transmitting power control is to be performed.

It is another object of the invention to keep a high signal-to-noise ratio of a transmission wave without changing a basic hardware construction even in a range in which the transmission wave is at low level.

It is still another object of the invention to keep a high signal-to-noise ratio of a transmission wave without performing a complicated processing through a feedback system.

It is still another object of the invention to simplify and standardize a construction.

It is still another object of the invention to set gains of two amplifiers, that are to be set in accordance with the level of a transmission wave, to values flexibly adaptable to hardware constructions and characteristics.

It is still another object of the invention to attain overall performance and characteristics with accuracy and stability without drastic changes due to deviations of characteristics of amplification elements applied to the two amplifiers.

It is still another object of the invention to constitute a system having linearity to levels of transmission waves and to simplify and save labor required for adjustment and confirming characteristics.

It is still another object of the invention to realize standardization of hardware construction and flexible adaptation to differences of the constructions and characteristics of the two amplifiers described above.

It is still another object of the invention to keep high transmission quality over a desired broad dynamic range and to accomplish transmitting power control with moderate price and reliability.

It is a further object of the invention to keep high service quality while flexibly adapting to diversified zone constructions and channel allocations.

The above objects can be accomplished by a transmitting power control equipment and a transmitting equipment which realizes transmitting power control by setting gains of an intermediate frequency stage and a high-frequency stage at values so that levels of transmission waves have desired values while keeping the gain of the intermediate frequency stage at a value so that the signal-to-noise ratio of an intermediate frequency signal inputted to the high-frequency stage becomes greater than or equal to a desired lower limit value.

In such transmitting power control equipment and transmitting equipment, it is able to highly maintain the signal-to-noise ratio of the transmission wave fed to an antenna system without changing a basic hardware construction even in a region where the transmission wave is at low level.

The above objects can be accomplished by a transmitting power control equipment and a transmitting equipment where the gains of an intermediate frequency stage and a high-frequency stage are set to values of first and second functions that are determined in advance for the levels of transmission waves.

In such transmitting power control equipment and transmitting equipment, it is possible to highly maintain the signal-to-noise ratio of the intermediate frequency signal (transmission wave) without performing any complicated processing under feedback control.

The objects described above can be accomplished by a transmitting power control equipment where a sum of the values of the first and second functions is given as a primary function of the level of a transmission wave.

In such transmitting power control equipment, the construction can be simplified and standardized.

The objects described above can be accomplished by a transmitting power control equipment where the gradient of the first function is set greater than the gradient of the second function in a region where the level of a transmission wave is lower than or equal to a first predetermined threshold value but it is set smaller than the gradient of the second function in a region where the level of the transmission wave is greater than or equal to a second threshold value which is smaller than or equal to the first threshold value.

In such transmitting power control equipment, the gain of a first amplifier (the value of the first function) and the gain of a second amplifier (the value of the second function) to be set in accordance with the level of a transmission wave, are set to values flexibly adaptable to the applied hardware construction and characteristics.

The objects described above can be accomplished by a transmitting power control equipment where the first and second functions are given as primary functions of the level of a transmission wave.

In such transmitting power control equipment, overall performance and characteristics can be obtained with accuracy and stability without a drastic change due to deviations of characteristics of active elements used for control sections.

The above objects can be accomplished by a transmitting power control equipment where the gradient of the first function in a region where the level of a transmission wave is lower than or equal to the first threshold value, is equal to the gradient of the second function in a region where the level of the transmission wave is higher than or equal to the second threshold value.

In the transmitting power control equipment having linearity to the level of a transmission wave, it is possible to simplify and save labor required for adjustment and confirmation of characteristics.

The objects described above can be accomplished by a transmitting power control equipment characterized in that the first and second threshold values are set equal.

In the transmitting power control equipment, the construction can be simplified compared to the case where the first and second threshold values are different.

The above objects can be accomplished by a transmitting power control equipment where one or both of the first and second functions adapted to the constructions or characteristics of one or both of the intermediate frequency stage and the high-frequency stage is/are determined in advance to employ the first or second function corresponding to one or both of these constructions and characteristics.

In such transmitting power control equipment, it is possible to standardize the hardware construction in addition to flexible adaptation to the differences of the constructions and characteristics of the first and second amplifiers.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram showing the principle of the invention;

FIG. 2 shows the first to third embodiments of the invention;

FIG. 3 is an explanatory view (1) useful for explaining the operation of the first embodiment of the invention;

FIG. 4 is an explanatory view (2) useful for explaining the operation of the first embodiment of the invention;

FIG. 5 is an explanatory view (3) useful for explaining the operation of the first embodiment of the invention;

FIG. 6 is an explanatory view useful for explaining the operation of the second embodiment of the invention;

FIG. 7 is an explanatory view (1) useful for explaining the operation of the third embodiment of the invention;

FIG. 8 is an explanatory view (2) useful for explaining the operation of the third embodiment of the invention;

FIG. 9 shows the fourth embodiment of the invention;

FIG. 10 shows a construction of a control table; and

FIG. 11 shows a structural example of a transmitting/receiving part of mobile station equipment that performs transmitting power control.

### DESCRIPTION OF THE PREFERRED EMBODIMENTS

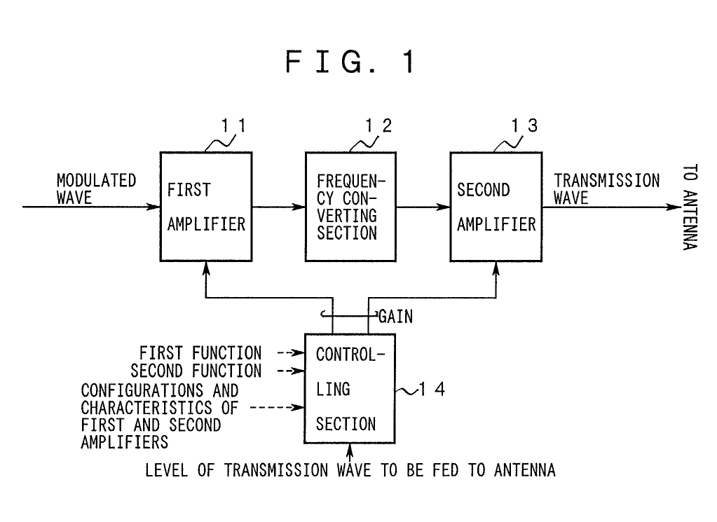

Referring initially to FIG. 1, the principle of power control equipment according to the invention will be explained.

FIG. 1 is a block diagram showing the principle of the invention.

Apower control equipment shown in FIG. 1 includes a first amplifier 11, a frequency conversion section 12, a second amplifier 13, and a control section 14.

The principle of the first power control equipment according to the invention is as follows.

The first amplifier 11 amplifies a modulated wave to output an intermediate frequency signal. The frequency conversion section 12 frequency-converts the intermediate frequency signal to generate a radio-frequency signal including the component of the intermediate frequency signal in its occupied band. The second amplifier 13 amplifies this radio-frequency signal to generate a transmission wave and feeds the transmission wave to an antenna system. The control section 14 keeps the combination of the gain of the first amplifier 11 and the gain of the second amplifier 13 at values at which the transmission wave reaches the receiving end at a prescribed level. The control section 14 further keeps during this process the gain of the first amplifier 11 at a value at which the signal-to-noise ratio of the intermediate frequency signal outputted from the first amplifier 11 is greater than or equal to a desired lower limit value of the level of the transmission wave.

In the power control equipment having the construction described above, the level of noise occurring inside the first amplifier 11 irrespective of the gain and superposed with the intermediate frequency signal is kept at a small value necessary for attaining the described signal-to-noise ratio because the control section 14 distributes the gains of the first and second amplifiers 11 and 13 as described above.

In consequence, the signal-to-noise ratio of the transmission wave supplied to the antenna system can be highly kept in a region where the level of the transmission wave is low, without changing the basic hardware construction.

The principle of the second power control equipment according to the invention is as follows.

The control section 14 sets the gains of the first and second amplifiers 11 and 13 as the values of the first and second functions, that are defined in advance for the level of the transmission wave to be supplied to the antenna system.

In the power control equipment having the construction described above, the first and second functions are given in advance so that the signal-to-noise ratio of the intermediate frequency signal (transmission wave) surely exceeds the predetermined lower limit value so long as deviation of the characteristics of the first and second amplifiers 11 and 13 is allowably small.

Therefore, the signal-to-noise ratio of the intermediate frequency signal (transmission wave) is highly maintained without performing complicated processing that is performed under feedback control.

In the third power control equipment according to the invention, the first and second function are such that a sum of the values of both functions is given as a primary function of transmitting power to be supplied to the antenna system.

In the power control equipment having such a construction, the controlling part 14 is able to set the gains of the first and second amplifiers 11 and 13 by executing fundamentally the same processing in accordance with the transmitting power so long as the first and second functions are defined in advance.

In consequence, it is possible to simplify and standardize the construction.

In the fourth power control equipment according to the invention, the gradient of the first function is greater than that of the second function in a region where the level of the transmission wave to be supplied to the antenna system is smaller than or equal to a first predetermined threshold value, and it is smaller than that of the second function in a region where the level of the transmission wave is greater than or equal to a second threshold value that is smaller than or equal to the first threshold value.

In the power control equipment having such a construction, either or both of the gain of the first amplifier 11 and the gradient of its gain is/are set to a greater value than the gain or its gradient of the second amplifier 13 disposed at a subsequent stage, in a region where the transmission wave to be supplied to the antenna system is at a low level.

Therefore, the gain of the first amplifier 11 (the value of the first function) and the gain of the second amplifier 13 (the value of the second function), that are to be set in accordance with the desired level of the transmission wave, can be set to values flexibly adaptable to the construction and characteristics of hardware employed.

In the fifth power control equipment according to the invention, the first and second functions are defined as primary functions of transmission power to be fed to the antenna system.

In the power control equipment having such a construction, the control section 14 is constituted as a linear circuit that operates in an active region without shifting to a cut-off region and a saturation region.

Therefore, overall performance and characteristics can be obtained with accuracy and stability without drastic changes that result from deviation of the characteristics of the active elements applied to the control section 14.

In the sixth power control equipment according to the invention, the gradient of the first function in the region where the level of the transmission wave to be fed to the antenna system is less than the first threshold value, is equal to the gradient of the second function in the region where the level of the transmission wave is greater than or equal to the second threshold value.

In the power control equipment having such a construction, the overall gain of the first and second amplifiers 11 and 13 is proportional to the level of the transmission wave to be fed to the antenna system even when both of the first and second functions are defined as nonlinear functions.

Therefore, the transmitting power control equipment according to the invention has linearity to the level of the transmission wave and realizes simplification and saving of labor required for adjustment and confirming the characteristics.

In the seventh power control equipment according to the invention, the first and second threshold values are set to an equal value.

In the power control equipment having such a construction, the gradients of the gains of the first and second amplifiers 11 and 13 are changed over in parallel with one another in accordance with the level of the transmission wave to be fed to the antenna system and the common threshold value.

Therefore, the construction can be simplified compared to the case where the first and second threshold values are different as described above.

In the eighth power control equipment according to the invention, the first and second functions are defined in advance as functions or a pair of functions individually adapted to a possible form of one or both of the construction and the characteristics of one or both of the first and second amplifiers 11 and 13. The control section 14 applies the function or the pair of functions corresponding to one or both of the constructions and the characteristics of these first and second amplifiers 11 and 13.

In the power control equipment having such a construction, it is possible to freely set the gains and the gradients of the gains of the first and second amplifiers 11 and 13 at values corresponding to all of the forms so long as the forms of the constructions and characteristics of the first and second amplifiers 11 and 13 are given in advance as known information.

Therefore, the power control equipment enables standardization of the hardware construction in addition to flexible adaptation to the differences of the constructions and characteristics of the first and second amplifiers 11 and 13.

Hereinafter, the principle of transmitting equipment according to the invention will be explained with reference to FIG. 1.

In the first to third transmitting equipment according to the invention, the first amplifier 11 amplifies a modulated wave (intermediate frequency signal) and the frequency conversion section 12 frequency-converts the signal so amplified to generate a radio-frequency signal including the component of the signal in its occupied band. The second amplifier 13 amplifies this radio-frequency signal to generate a transmission wave and feeds the transmission wave to the antenna system. The control section 14 sets a combination of the gains of the first and second amplifiers 11 and 13 in the following way in order to vary the level of the transmission wave under transmitting power control.

In other words, the control section 14 varies the gain of the second amplifier with transmitting power P to be set under transmitting power control, and sets the gain G1 of the first amplifier at a value of a function F1(P)=K1 having a gradient K1 of zero or more in a region, in which the gain of the second amplifier is varied under the transmitting power control so that a function F1(P)=K1 denoting a relation between transmitting power P and the gradient K1 becomes a broadly-defined monotone decreasing function(excepting functions in which the gradient identically has a positive number).

The control section 14 sets the gain G2 of the second amplifier to a value of a function G2=f2(P). This function has a gradient K2 of zero or more in the range of transmitting power control so that a function F2(P)=K2 denoting a relation between transmitting power P and the gradient K2 becomes a broadly-defined monotone increasing function(excepting functions in which the gradient identically has a positive number).

The control section 14 varies the gain of the first amplifier 11 without varying the gain of the second amplifier 13 in the first control range in which transmitting power P has a value of P1 to P3 (P1<P3<P2) within the range of transmitting power control P1 to P2 (P1<P2). The control section 14 varies the gain of the second amplifier 12 without varying the gain of the first amplifier 11 within the second control range in which the transmitting power P has a value of P3 to P2.

In consequence, the signal-to-noise ratio of the transmission wave fed to the antenna system is highly kept in the region in which the transmission wave is at a low level.

Next, the embodiments of the invention will be explained in detail with reference to the drawings.

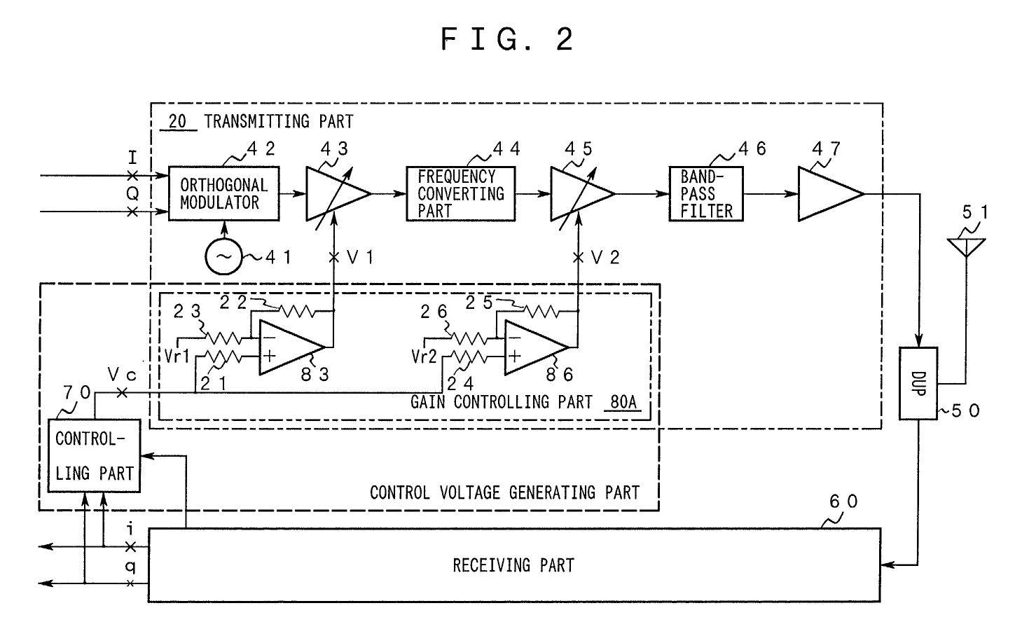

FIG. 2 shows the first to third embodiments of the invention.

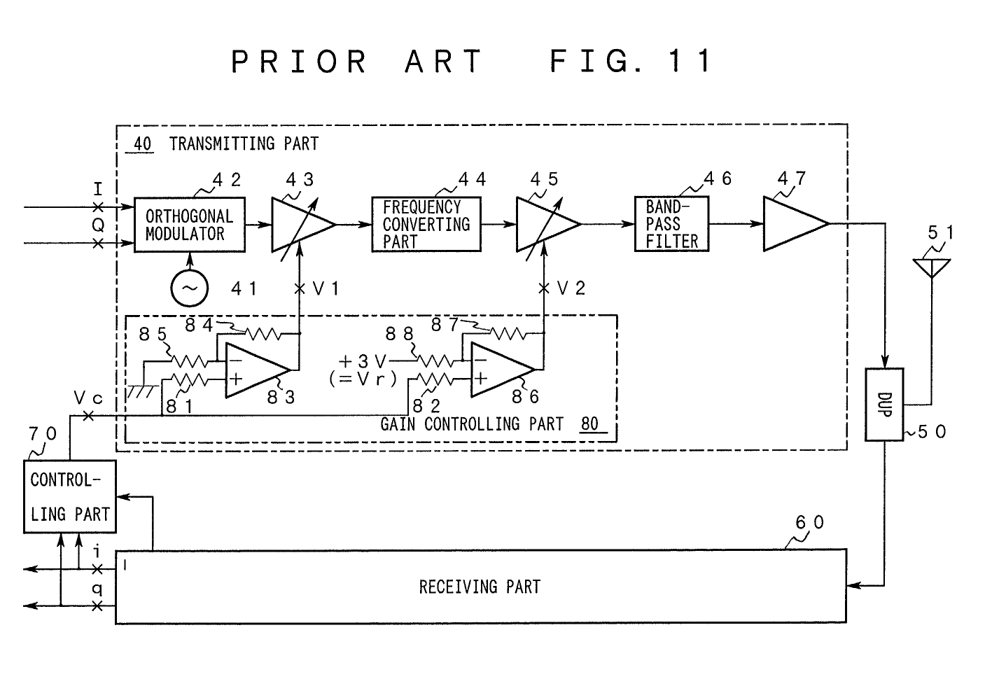

These embodiments are different from the prior art example shown in FIG. 11 in that a transmitting part 20 is provided in place of the transmitting part 40, that this transmitting part 20 constitutes a “control voltage generating part” in cooperation with the aforementioned controlling part 70 indicated by thick broken lines in FIG. 2, and that a gain controlling part 80A having a different construction from the gain controlling part 80 shown in FIG. 11 in the following points is provided:

resistors 21, 22 and 23 are disposed in place of the resistors 81, 84 and 85;

one of the ends of the resistor 23 is not grounded, and an after-mentioned reference voltage Vr1 is applied to this one end;

resistors 24, 25 and 26 are disposed in place of the resistors 82, 87 and 88; and

an after-mentioned reference voltage Vr2 is applied to one of the ends of the resistor 26 in place of the reference voltage Vr.

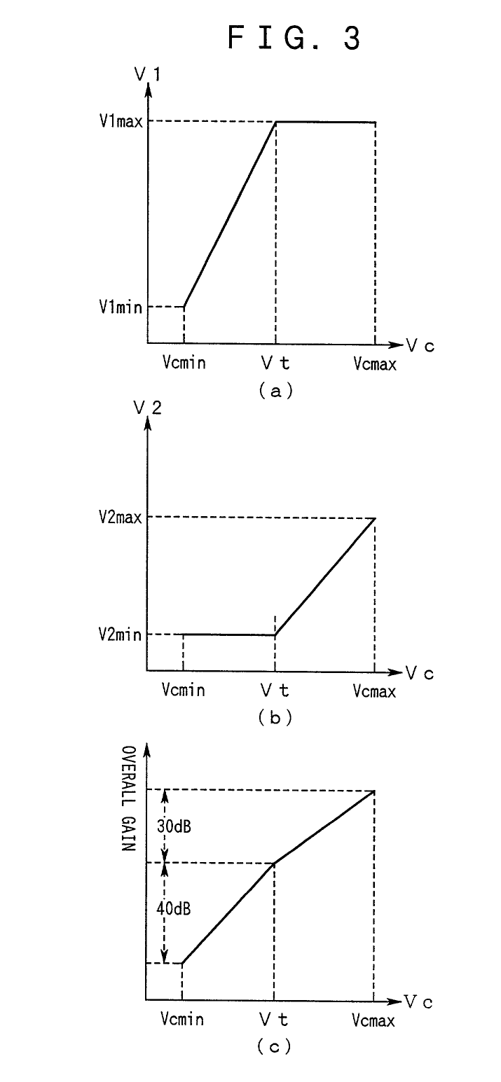

FIG. 3 is an explanatory view (1) useful for explaining the operation of the first embodiment of the invention.

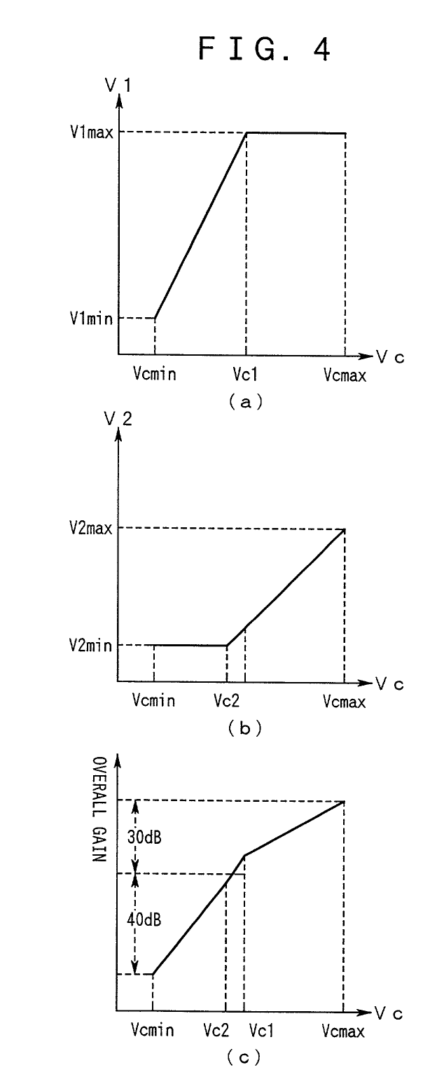

FIG. 4 is an explanatory view (2) useful for explaining the operation of the first embodiment of the invention.

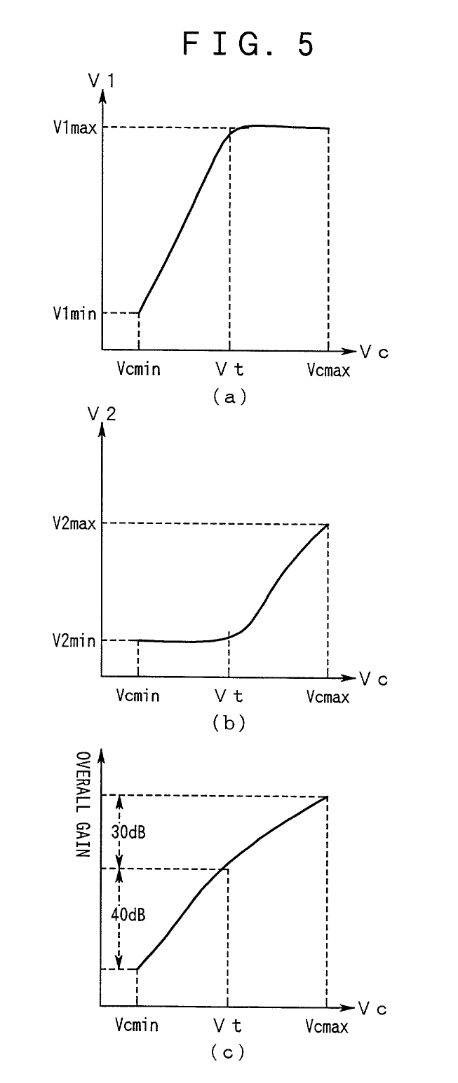

FIG. 5 is an explanatory view (3) useful for explaining the operation of the first embodiment of the invention.

Hereinafter, the operation of the first embodiment of the invention will be explained with reference to FIGS. 2 to 5.

The intermediate frequency amplifier 43 is provided in advance with the following values as the design values or actually measurement values as shown in FIG. 3(a):

control voltage V1max to be given when the gain G1 is the maximum value G1max; and

control voltage V1min to be given when the gain G1 is a value lower by 40 dB than the maximum value G1max.

The high-frequency amplifier 45 is provided in advance with the following values as the design values or actually measurement values as shown in FIG. 3(b):

control voltage V2max to be given when the gain G2 is a maximum value G2max; and

control voltage V2min to be given when the gain G2 is a value lower by 30 dB than the maximum value G2max.

The overall gain G to be obtained by the intermediate frequency amplifier 43 and the high-frequency amplifier 45 (hereinafter called merely the “overall gain”; G=G1+G2) is defined in advance as a function G(Vt) given as two straight lines having a common value of the control voltage Vc to be given by the controlling part 70 when the overall gain takes a value lower by 30 dB than its maximum value and interconnected to each other by two-dimensional rectangular coordinates.

The resistance values of the resistors 21 to 23 constituting a DC amplifier in cooperation with the operational amplifier 83 and the aforementioned reference value Vr1 are set in advance to those values which satisfy all the following conditions (hereinafter called the “first condition”):

When the control voltage Vc exceeds the value Vt described above, the operational amplifier 83 remains within a saturation region, and the potential V1 of the output of the operational amplifier 83 is kept with predetermined accuracy at a value equal to V1max irrespective of the value of this control voltage Vc; and

when the values of the control voltage Vc are lower than Vt, the operational amplifier 83 operates as a non-inverting amplifier in the active region, and when the control voltages Vc have the value Vt provided in the transmitting power control process and Vcmin (<Vt), the gain G1 is the maximum value G1max and a value smaller by 40 dB than the maximum value G1max.

The resistance values of the resistors 24 to 27 constituting a DC amplifier in cooperation with the operational amplifier 86 and the aforementioned reference voltage Vr2 are set in advance to those values which satisfy all the following conditions (hereinafter called the “second condition”):

When the values of the control voltage Vc are smaller than Vt, the operational amplifier 86 remains within the cut-off region, and the potential V2 of the output of the operational amplifier 86 is kept with predetermined accuracy at a value equal to V2min described above irrespective of the value of the control voltage VC; and

when the values of the control voltages Vc are greater than Vt, the operational amplifier 86 operates as the non-inverting amplifier in the active region, and when the control voltages Vc are Vcmax (>Vt) given in the transmitting power control process and Vt, the gain G2 is the maximum value G2max and a value lower by 30 dB than G2max.

In other words, when the level of the transmission wave set under transmitting power control is within the region from the maximum value that the level can take to the value lower by 30 dB than the maximum value (hereinafter called merely the “high power region”), the gainG1 of the intermediate frequency amplifier 43 is kept at the maximum value G1max and the gain G2 of the high-frequency amplifier 45 is set to a value proportional to the control voltage Vc representing the level of the transmission wave that is practically transmitted.

Inside the region where the level of the transmission wave set under transmitting power control is smaller than the minimum value it can take in the high power region (hereinafter called the “low power region”), the gain G2 of the high-frequency amplifier 45 is kept at the minimum value G2min described above and the gain GI of the intermediate frequency amplifier 43 is set to a value proportional to the control voltage Vc representing the level of the transmission wave to be practically transmitted.

In this embodiment, the gain G1 of the intermediate frequency amplifier 43 is reliably set, in the low power region, to a value greater than the value of the prior art example in which the gain G2 of the high-frequency amplifier 45 disposed in the subsequent stage of the intermediate frequency amplifier 43 is not kept at the minimum value G2min but becomes greater than the minimum value G2min.

In other words, even when the sum of the maximum values G1max and G2max of the gain G1 of the intermediate frequency amplifier 43 and the gain G2 of the high-frequency amplifier 45, that are set in accordance with the control voltage Vc, is the same as that of the prior art example, the former of the gains G1 and G2 is kept at a value greater than that of the prior art example while the latter is kept at a smaller value irrespective of the control voltage Vc.

For this reason, the ratio of the level S of the intermediate frequency signal obtained at the output of the intermediate frequency amplifier 43 to the level N of the noise occurring in the intermediate frequency amplifier 43 and superposed with the intermediate frequency signal becomes reliably higher than the signal-to-noise ratio of the prior art example.

In this embodiment, the value of the control voltage Vc (=Vc1) at which the operational amplifier 83 is to shift from the active region to the saturation region and the value of the control voltage Vc (=Vc2) at which the operational amplifier 86 is to shift from the cut-off region to the active region are set to the aforementioned value Vt.

However, the invention is not limited to such a construction. In other words, the values Vc1 and Vc2 of the control voltage may assume different values as shown in FIGS. 4(a) to (c) provided that the sum of the gain G1 of the intermediate frequency amplifier 43 and the gain G2 of the high-frequency amplifier 45 can be obtained with desired accuracy relative to the control voltage Vc.

In this embodiment, the control voltages V1 and V2 outputted by the operational amplifiers 83 and 86 take the values proportional to the value of the control voltage Vc in the low power region and in the high power region, respectively.

However, the invention is not limited to such a construction. For example, non-linear elements may be added to the operational amplifiers 83 and 86 so that a desired overall gain of the control voltages V1 and V2 varies with the control voltage Vc and is given as an approximate value as shown in FIG. 5.

Under the condition where the control voltage takes the value Vt to Vcmax within the range of transmitting power control in which the control voltage outputted by the control part 70 takes the value of Vcmin to Mcmax, the control voltage applied to the intermediate frequency amplifier 43 through the operational amplifier 83 is kept at a constant value V1max as shown in FIG. 3(a).

In other words, the gradient of the function G1=f(P) representing the correspondence between transmitting power (P) and the gain (G) of the intermediate frequency amplifier 43 identically remains zero under such a condition. Therefore, in comparison with the prior art example in which the gain of the intermediate frequency amplifier 43 is set to a smaller value when transmitting power is set to a smaller value, the signal-to-noise ratio of the output signal of the intermediate frequency amplifier 43 in this embodiment remains excellent during the process in which transmitting power is gradually updated to a smaller gain value from high transmitting power at which the control voltage outputted by the control part 70 is Vcmax.

Incidentally, the gradient of the function f1(P)=G1 representing correspondence between transmitting power P and the gain (G1) of the intermediate frequency amplifier 43 is identically set to zero.

However, the signal-to-noise ratio of the output signal of the intermediate frequency amplifier 43 is kept at a higher ratio than in the prior art example even when the construction of the gain controlling part 80A, the controlling part 70, and so forth, are modified so that the gradient becomes greater than zero and the function F1(P)=K1 representing the correspondence between transmitting power P and the gradient K1 becomes in a broad sense a monotone decreasing function (with the exception of those in which the gradient identically has a positive number).

In this embodiment, the gain (G2) of the high-frequency amplifier 45 is given as a function (G2=f2(P)) of transmitting power P as shown in FIG. 3(b), and the control voltage may be applied to the high-frequency amplifier 45 so that the gradient of the function f2(P) is zero within the range of transmitting power control and the function (F2(P)=K2) representing the correspondence between transmitting power P and the gradient (K2) becomes in a broad sense a monotone increasing function (with the exception of the functions in which the gradient identically has a positive number). In this way, the follow-up property of transmitting power to the change of the control voltage may be improved.

The controlling part 70 and the gain controlling part 80A apply the control voltages to the first and second amplifiers 11 and 13 within the first control range P1 to P3 satisfying the relation P1<P3 and within the second control range P3 to P2 satisfying the relation P1<P3 <P2 inside the range P1 to P2 of transmitting power control, respectively.

In other words, as shown in FIG. 3, a predetermined control voltage V2min is applied to the high-frequency amplifier 45 within the first control range described above, and the control voltage to be applied to the intermediate frequency amplifier 43 is varied. Within the second control range described above, a predetermined control voltage V1max is applied to the intermediate frequency amplifier 43 and the control voltage to be applied to the high-frequency amplifier 45 is varied.

In other words, during the process in which transmitting power is increased from a low transmitting power value, all the incremental quantity of the gain are allotted to the intermediate frequency amplifier 43 within the range of transmitting power control described above. During the process in which transmitting power is updated from a high transmitting power value to a low value, on the other hand, the gain of the intermediate frequency amplifier 43 is kept constant. Therefore, the signal-to-noise ratio becomes higher than in the prior art example.

In the control voltage generation part (controlling part 70) described above, the gain (G1) of the intermediate frequency amplifier 43 is given as the function (G1=fl(P)) of transmitting power (P) within the range P1 to P2 of transmitting power control, and the control voltage to be applied to this intermediate frequency amplifier 43 is set so that the gradient of the function (f1(P)) is zero and the function (F1(P)=K1) representing the correspondence between transmitting power P and the gradient (K1) becomes in a broad sense a monotone increasing function (with the exception of those in which the gradient identically has a positive number). Furthermore, the gain (G2) of the high-frequency amplifier 45 is given as the function (G2=f2(P)) of transmitting power (P), and the control voltage to be given to the high-frequency amplifier 45 so that the function (F2(P)=K2) representing the correspondence between transmitting power P and the gradient (K2) becomes in a broad sense a monotone increasing function (with the exception of those in which the gradient identically has a positive number).

The transmitting power control range P1 to P2 is divided into at least two ranges including the first control range P1 to P3 and the second control range P3 to P2 (P1<P3<P2). To the intermediate frequency amplifier 43 and the high-frequency amplifier 45 are applied control voltages such that the maximum value of K1 within the first control range is greater than the maximum value of K1 in the second control range and the maximum value of K2 within the first control range is smaller than the maximum value of K2 within the second control range.

In consequence, the signal-to-noise ratio can be improved more than in the prior art example, although the effect is inferior to an effect obtained when the gain of the high-frequency amplifier 45 is kept constant within the first control range and the gain of the intermediate frequency amplifier 43 is kept constant within the second control range.

The control range described above may be divided into three or more ranges. In such a case, the greater the suffix representing the individual control range, the greater becomes the maximum value of K1 in the control range, and the maximum value of K2 has preferably a small value, on the contrary.

Next, the second embodiment of the invention will be explained.

The difference of the second embodiment from the first embodiment described above resides in that the resistance values of the resistors 21 to 23 and 24 to 26 and the reference voltages Vr1 and Vr2 are set in advance to the after-mentioned values.

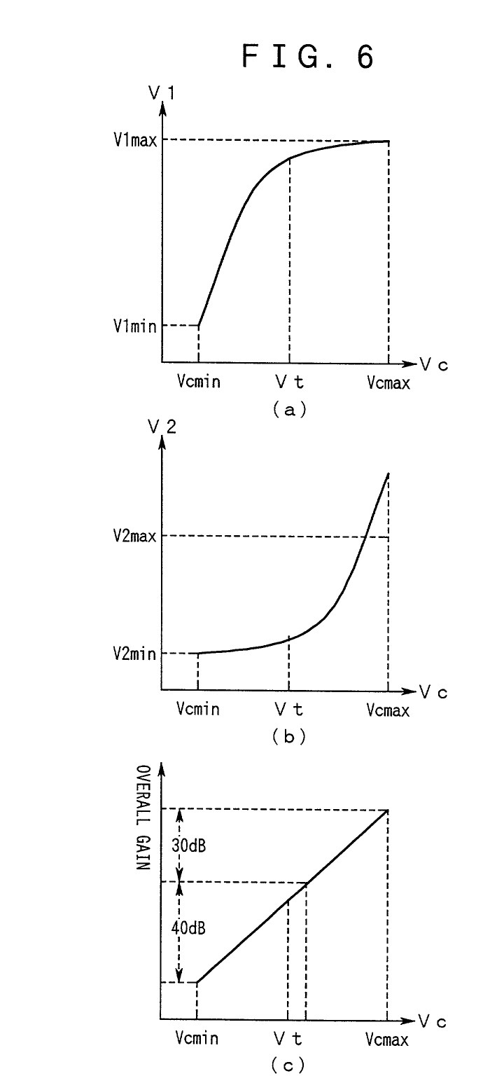

FIG. 6 is an explanatory view of the operation of the second embodiment according to the invention.

Hereinafter, the operation of the second embodiment according to the invention will be explained with reference to FIGS. 2 to 7.

The resistance values of the resistors 21 to 23 and 24 to 26 and the reference voltage Vr1, Vr2 are set in advance at values, which satisfy the following conditions together with the first and second conditions described:

The control voltage V1 obtained at the output of the operational amplifier 83 in accordance with the control voltage Vc offsets, with desired accuracy, non-linearity of the characteristics representing the gain G1 set to the intermediate frequency amplifier 43 in accordance with the control voltage V1 (FIG. 6(a));

The control voltage V2 obtained at the output of the operational amplifier 86 in accordance with the control voltage Vc offsets, with desired accuracy, non-linearity of the characteristics representing the gain G2 set to the high-frequency amplifier 45 in accordance with the control voltage V2 (FIG. 6(b)); and

The sum of the gains G1 and G2 set to the intermediate frequency amplifier 43 and to the high-frequency amplifier 45, respectively, becomes the value proportional to the control voltage Vc relative to the value that the control voltage Vc can take (FIG. 6(a)).

In other words, the level of the transmission wave (overall gain of the intermediate frequency amplifier 43 and the high-frequency amplifier 45) can be obtained as a value proportional to the value of the control voltage Vc given by the controlling part 70.

In this embodiment, therefore, the proportional relationship between the control voltage Vc and the level of the transmission wave can be maintained throughout the range of the value of the control voltage Vc, and the labor necessary for adjustment, maintenance and repair of the transmitting part 20 can be simplified.

In each of the foregoing embodiments, the deviation and non-linearity of the characteristics of the operational amplifiers 83 and 86 are not considered.

However, the invention is not limited to such a construction. For example, the resistance values of the resistors 21 to 23 and 24 to 26 and the reference voltages Vr1 and Vr2 may be set to those values which offset non-linearity of these operational amplifiers 83 and 84.

Next, third embodiment of the invention will be explained.

The difference of the third embodiment from the first embodiment resides in that the resistance values of the resistors 21 to 23 and 24 to 26 and the reference voltages Vr1 and Vr2 are set to the after-mentioned values, respectively.

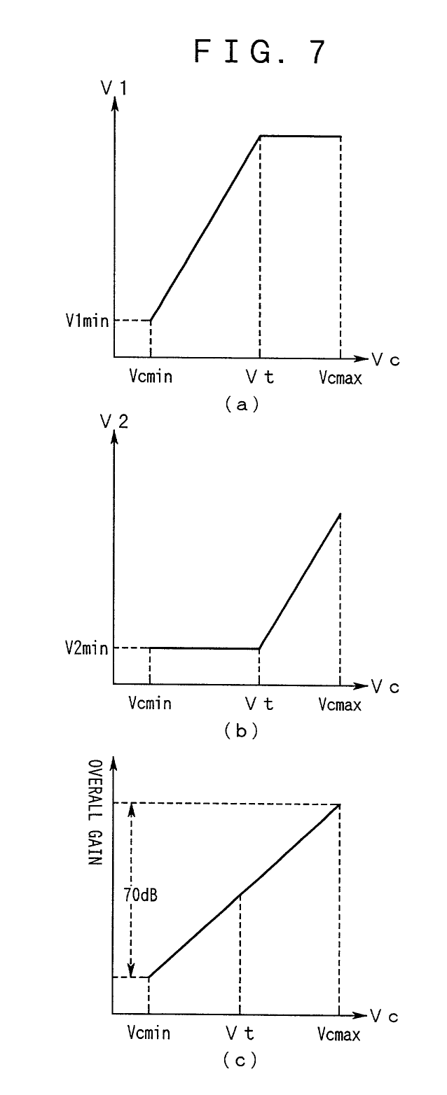

FIG. 7 is an explanatory view (1) useful for explaining the operation of the third embodiment of the invention.

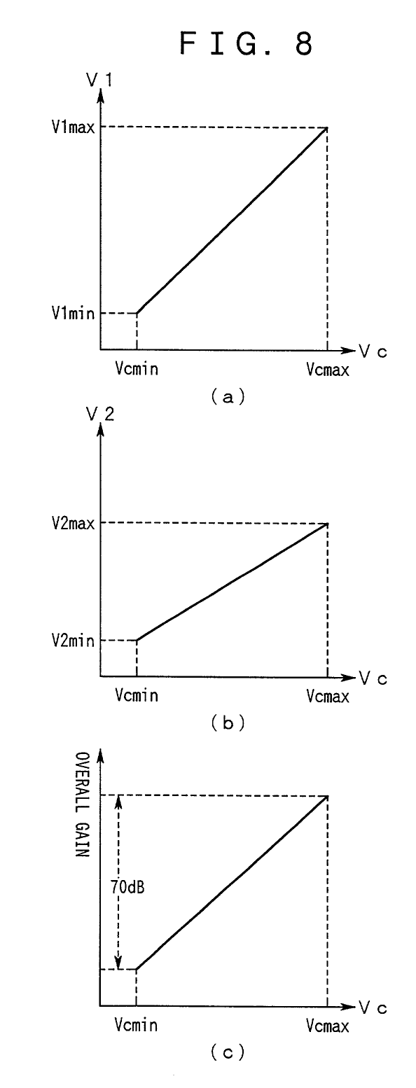

FIG. 8 is an explanatory view (2) useful for explaining the operation of the third embodiment of the invention.

The operation of the third embodiment of the invention will be explained with reference to FIGS. 2, 7 and 8.

The resistance values of the resistors 21 to 23 and 24 to 26 and the reference voltages Vr1 and Vr2 are set in advance to the values that satisfy all the following conditions as shown in FIGS. 7(a) and (b):

* The gradient of the control voltage V1 obtained at the output of the operational amplifier 83 in accordance with the control voltage Vc in the low power region is equal to the gradient of the control voltage V2 obtained at the output of the operational amplifier 86 in accordance with the control voltage Vc in the high power region; and

Both of the value of the control voltage Vc at which the operational amplifier 86 shifts from the active region to the saturation region and the value of the control voltage Vc at which the operational amplifier 86 shifts from the cutoff region to the active region are equal to Vt described already.

For the sake of simplification, it will be assumed hereby that the gradient of the gain GI of the intermediate frequency amplifier 43 varied with the control voltage V1, is equal to the gradient of the gain G2 of the high-frequency amplifier 45 varied with the control voltage V2.

When the resistance values of the resistor 21 to 23 and 24 to 26 and the reference voltages Vr1 and Vr2 are set to the values described above, the operational amplifiers 83 and 86 have a share of varying the overall gain of the intermediate frequency amplifier 43 and the high-frequency amplifier 45 with the control voltage Vc in the low power region and in the high power region, respectively. In addition, the gradient of the overall gain with respect to the control voltage Vc is equal in both low power region and high power region.

According to this embodiment, the level of the transmission wave takes the value proportional to the value of the control voltage Vc given by the controlling part 70 in the same way as in the second embodiment without disposing the elements having non-linear characteristics in the periphery of the operational amplifiers 83 and 86 or without employing a circuit requiring a number of man-hours for selection of the elements and adjustment of characteristics so long as the gradients of the gains of the intermediate frequency amplifier 43 and the high-frequency amplifier 45 are regarded as constant.

Therefore, this embodiment can simplify the works required for adjustment, maintenance and repair of the transmitting part 20 in comparison with the case where the proportional relationship between the control voltage Vc and the level of the transmission wave is acquired only at a part of the range of the control voltage Vc.

Incidentally, the resistance values of the resistors 21 to 23 and 24 to 26 and the reference voltages Vr1 and Vr2 are set in this embodiment on the premise that the gradient of the gain G1 of the intermediate frequency amplifier 43 varied with the control voltage V1 is equal to the gradient of the gain G2 of the high-frequency amplifier 45 varied with the control voltage V2.

However, the invention is not limited to such a construction. When, for example, the gradient of the gain G1 of the intermediate frequency amplifier 43 varied with the control voltage V1 is different from the gradient of the gain G2 of the high-frequency amplifier 45 varied with the control voltage V2 and both, or one, of them is regarded as a nonlinear function not proportional to the corresponding control voltage, non-linear elements for accomplishing the following compensation may be added to both, or one, of the operational amplifiers 83 and 86:

compensation of the difference between the gradient of the gain G1 of the intermediate frequency amplifier 43 varied with the control voltage V1 and the gradient of the gain G2 of the high-frequency amplifier 45 varied with the control voltage V2; and

compensation of the non-linear change of both, or either one, of these gradients with respect to the control voltages V1 and V2.

In this embodiment, the operational amplifiers 83 and 86 that predominantly vary the overall gain with the control voltages Vc in the low and high power regions, respectively, have a share of varying the overall gain of the intermediate frequency amplifier 43 and the high-frequency amplifier 45.

The invention is not limited to the construction described above. For example, as shown in FIGS. 8(a) to (c), the resistance values of the resistors 21 to 23 and 24 to 26 and the reference voltages Vr1 and Vr2 may be set in such a manner as to satisfy the following conditions and to select performance (models) of the operational amplifiers 83 and 86, the intermediate amplifier 43 and the high-frequency amplifier 45:

the maximum gain G1max that the intermediate frequency amplifier 43 can take in accordance with the control voltage V1 is set to the greatest possible value;

the operational amplifiers 83 and 86 operate as DC amplifiers each having linear input output characteristics in the active region in both low and high power regions; and

both or either one, of the operating point and the gain of the DC amplifier including the operational amplifier 83 among these DC amplifiers takes the highest possible value in the region in which the gradient of the gain G1 of the intermediate frequency amplifier 43 obtained in accordance with the control voltage Vc is to be regarded as constant.

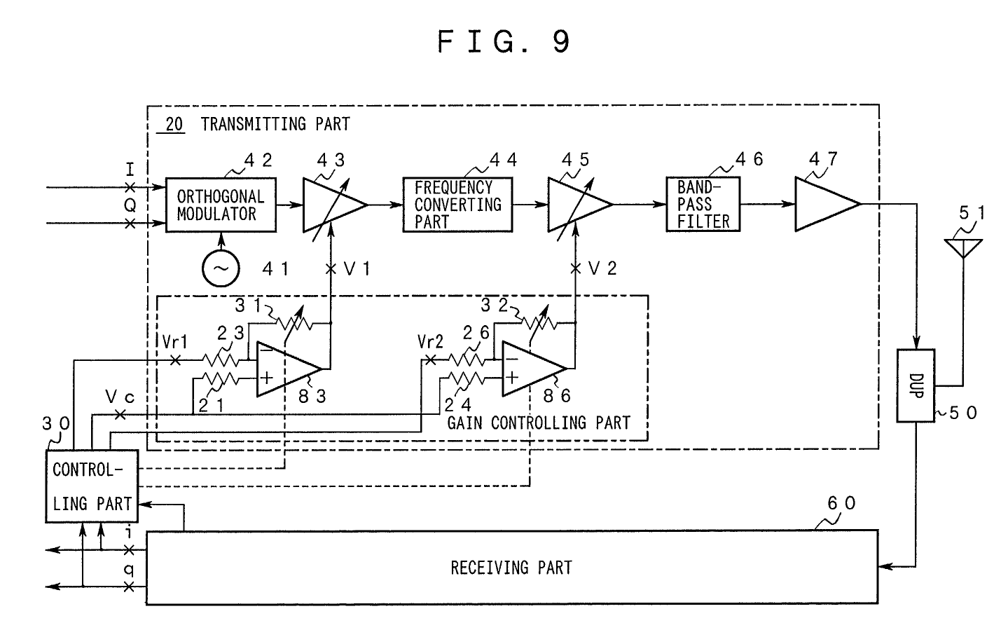

FIG. 9 shows the fourth embodiment according to the invention.

The structural differences of this embodiment from the first to third embodiments are as follows. A controlling part 30 is disposed in place of the controlling part 70, variable resistors 31 and 32 are disposed in place of the resistors 22 and 25, control terminals of these variable resistors 31 and 32 are connected to the corresponding output ports of the controlling part 30, and the reference voltages Vr1 and Vr2 are given by two analog ports of the controlling part 30.

Next, the operation of the fourth embodiment of the invention will be explained with reference to FIG. 9.

In a predetermined storage area inside a main storage area of the controlling part 30 disposed is a ROM (not shown) which stores a program executed by the controlling part 30 and realizing the described channel control and other processing, and constants to be appropriately referred to during the process of executing the program.

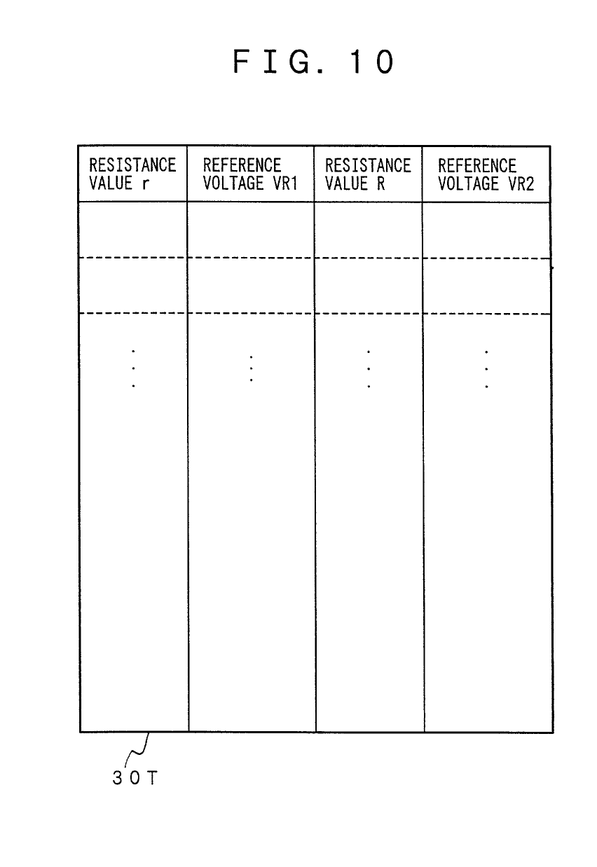

In a specific storage area of the ROM as shown in FIG. 10 disposed is a control table 30T comprising an array of records constituted as a group of the following fields and corresponding to all the combinations of the characteristics (or models) of the intermediate frequency amplifier 43 and the high-frequency amplifier 45 that can be actually provided in the transmitting part 20:

the resistance value r of the resistor 31 and the reference voltage Vr1 giving the gain and the operating point to be set to the DC amplifier including the operational amplifier 83 in accordance with the characteristics (models) of the intermediate frequency amplifier 43 contained in the corresponding combination; and

the resistance value R of the resistor 32 and the reference voltage Vr2 giving the gain and the operating point to be set to the DC amplifier including the operational amplifier 86 in accordance with the characteristics (models) of the high-frequency amplifier 45 contained in the corresponding combination.

These gain and operating points may be those which are used for the first to third embodiments described above.

The combination of the characteristics (models) of the intermediate frequency amplifier 43 and the high-frequency amplifier 45 provided actually to the transmitting part 20 (hereinafter called “package information”) is written in advance to other storage area of the ROM described above.

The overall gain of the intermediate frequency amplifier 43 and the high-frequency amplifier 45, that is to be varied under transmitting power control, is assumed hereby as a predetermined value (70 dB) for the sake of simplicity in the same way as in the first to third embodiments.

The controlling part 30 refers to the package information described above during initialization process which is executed at the start of the operation according to a predetermined procedure, and specifies a record corresponding to the package information (hereinafter called the “specific record”) among the records of the control table 30T.

The controlling part 30 acquires the resistance values r and R and the reference voltages Vr1 and Vr2 contained in this specific record.

The controlling part 30 sets the resistance values r and R to the variable resistors 31 and 32, and applies the reference voltages Vr1 and Vr2 to one of the ends of the resistors 85 and 88, respectively.

In other words, even when the characteristics (models) of the intermediate frequency amplifier 43 and the high-frequency amplifier 45 can change in diversified ways, the signal-to-noise ratio of the transmission wave can be kept at a high value over a broad dynamic range in which transmitting power control is to be made, so long as the resistance values r and R and the reference voltages Vr1 and Vr2 corresponding to the combination of these characteristics (models) can be determined in advance and are stored in the control table 30T described above.

Incidentally, the package information is written beforehand as a constant into the ROM.

However, such package information may be given as a state of mechanical contact such as a dip switch or may be written in advance into a non-volatile memory (CMOS memory, etc) to which the information can be written through any tool and the controlling part 30 can refer.

The intermediate frequency amplifier 43 and the high-frequency amplifier 45 may directly apply the package information to the controlling part 30, or the controlling part 30 may monitor in a predetermined frequency the characteristics (performance) of these intermediate frequency amplifier 43 and high-frequency amplifier 45 to obtain and discriminate the package information. This may leads to saving labor necessary for adjustment and maintenance and realizing flexible adaptation to the fluctuation of these characteristics (performance).

In each of the foregoing embodiments, the input output characteristics of the gain controlling part are kept constant unless the characteristics (performance) of the intermediate frequency amplifier 43 and the high-frequency amplifier 45 change.

However, the invention is not limited to the constructions described above. For example, it is possible to employ the construction that monitors the signal-to-noise ratio of the intermediate frequency signal obtained at the output of the intermediate frequency amplifier 43, and sets the gain G1 of the intermediate frequency amplifier 43 to a value such that the signal-to-noise ratio exceeds a predetermined lower limit value on the basis of the feedback control.

The invention is not limited to the above embodiments and various modifications may be made without departing from the spirit and the scope of the invention. Any improvement may be made in part or all of the components.

What is claimed is:

1. A transmitting power control equipment comprising:
a first amplifier for amplifying a modulated wave to output an intermediate frequency signal;
frequency converting means for frequency-converting said intermediate frequency signal outputted by said first amplifier to generate a radio frequency signal including a component of said intermediate frequency signal in its occupied band;
a second amplifier for amplifying said radio frequency signal generated by said frequency converting means to generate a transmission wave and feeding the transmission wave to an antenna system; and
controlling means for maintaining a combination of a gain of said first amplifier and a gain of said second amplifier so that said transmission wave reaches a receiving end at a prescribed level, and
wherein said controlling means keeps a gain of said first amplifier at a value at which a signal-to-noise ratio of said intermediate frequency signal outputted by said first amplifier becomes greater than or equal to a desired lower limit value of a level of said transmission wave.

2. The transmitting power control equipment according to claim 1, wherein said controlling means respectively sets gains of said first and second amplifiers as values of first and second functions, which are defined in advance with respect to a level of a transmission wave to be fed to said antenna system.

3. The transmitting power control equipment according to claim 2, wherein said first and second functions are such that a sum of values of said functions is given as a primary function of transmitting power to be fed to said antenna system.

4. The transmitting power control equipment according to claim 2, wherein a gradient of said first function is:
greater than a gradient of said second function in a region wherein the level of said transmission wave to be fed to said antenna system is smaller than or equal to a first predetermined threshold value; and
smaller than the gradient of said second function in a region wherein the level of said transmission wave is greater than or equal to a second threshold value that is smaller than or equal to said first threshold value.

5. The transmitting power control equipment according to claim 3, wherein a gradient of said first function is:
greater than a gradient of said second function in a region wherein the level of said transmission wave to be fed to said antenna system is smaller than or equal to a first predetermined threshold value; and
smaller than the gradient of said second function in a region wherein the level of said transmission wave is greater than or equal to a second threshold value that is smaller than or equal to said first threshold value.

6. The transmitting power control equipment according to claim 3, wherein both of said first and second functions are primary functions of transmitting power to be fed to said antenna system.

7. The transmitting power control equipment according to claim 4, wherein the gradient of said first function in a region wherein transmitting power to be fed to said antenna system is less than said first threshold value, is equal to the gradient of said second function in a region where transmitting power is greater than or equal to said second threshold value.

8. The transmitting power control equipment according to claim 5, wherein the gradient of said first function in a region wherein transmitting power to be fed to said antenna system is less than said first threshold value, is equal to the gradient of said second function in a region where transmitting power is greater than or equal to said second threshold value.

9. The transmitting power control equipment according to claim 4, wherein said first and second threshold values are set to an equal value.

10. The transmitting power control equipment according to claim 5, wherein said first and second threshold values are set to an equal value.

11. The transmitting power control equipment according to claim 7, wherein said first and second threshold values are set to an equal value.

12. The transmitting power control equipment according to claim 8, wherein said first and second threshold values are set to an equal value.

13. The transmitting power control equipment according to claim 2, wherein said controlling means is given in advance said first function or said second function as a function or a pair of functions adapted individually to a possible form of one or both of constructions and characteristics of one or both of said first and second amplifiers; and
employs said function or said pair of functions corresponding to one or both of the constructions and characteristics of said first and second amplifiers.

14. A transmitting equipment comprising:
a first amplifier for amplifying an intermediate frequency signal;
frequency converting means for frequency-converting said intermediate frequency signal fed through said first amplifier to generate a radio frequency signal;
a second amplifier for amplifying said radio frequency signal generated by said frequency converting means; and
controlling means for varying a gain of said second amplifier with transmitting power P to be set under transmitting power control, and setting the gain G1 of said first amplifier at a value of a function G1=f1(P) having a gradient K1 of zero or more in a region wherein said the gain of said amplifier is varied under the transmitting power control, so that a function F1(P)=K1 denoting a relation between transmitting power P and the gradient K1 becomes a broadly-defined monotone decreasing function (excluding functions whose gradient identically has a positive number).

15. The transmitting equipment according to claim 14, wherein said controlling means sets a gain G2 of said second amplifier at a value of a function G2=f2 (P) having a gradient K2 of zero or more in said range so that a function F2(P)=K2 denoting a relation between said transmitting power P and the gradient K2 becomes a broadly-defined monotone increasing function (excluding functions whose gradient identically has a positive number).

16. A transmitting equipment comprising:
a first amplifier for amplifying an intermediate frequency signal;
frequency converting means for frequency-converting said intermediate frequency signal fed through said first amplifier to generate a radio frequency signal;
a second amplifier for amplifying said radio frequency signal generated by said frequency converting means; and
controlling means for varying a gain of said first amplifier without varying a gain of said second amplifier in a first transmitting power control range as a part of a range wherein transmitting power control is performed, and
varying a gain of said second amplifier without varying a gain of said first amplifier in a second transmitting power control range wherein transmitting power is set to a greater value than in said first transmitting power control range.
